(19) United States
(12) Patent Application Publication
(10) Pub. No.: US 2020/0278453 A1
(43) Pub. Date: Sep. 3, 2020

(54) MODULAR HARDWARE TRACKER

(71) Applicant: INTEL CORPORATION, Santa Clara, CA (US)

(72) Inventors: Avinoam Levy, Petah Tikva (IL); Xiongfei Liao, Singapore (SG); Yu Juan Wang, Singapore (SG); Liang Lixin, Singapore (SG); Ory Eger, Tel Aviv (IL)

(21) Appl. No.: 16/650,132

(22) PCT Filed: Sep. 29, 2017
(86) PCT No.: PCT/US2017/054411

§ 371 Date: Mar. 24, 2020

(51) Int. Cl. G01S 19/32; G01S 19/37

(52) U.S. Cl. CPC G01S 19/32; G01S 19/37

(57) ABSTRACT

A signal tracker and a method of tracking signals are disclosed. For example, the method, by a pre-processor, for each sampling interval of a received signal stores samples of the sampling interval at consecutive memory locations and determines a bandwidth factor, by an allocator, for each sampling interval, allocates the samples stored at each of the memory locations to a respective one of consecutive tracking channels in consecutive processing cycles, and, by a processor comprising at least one hardware sub-processor, for each sampling interval, sequentially processes the samples of the sampling interval in accordance with the allocation, wherein each hardware sub-processor tracks one of the consecutive tracking channels.

The present disclosure describes a signal tracker, and a method for tracking signals, e.g., signals from satellites or cell towers. For example, the method may be for enabling sharing of hardware components (i.e., hardware sub-processors) used for tracking signals having different bandwidths, e.g., signals transmitted by legacy and modern satellites.

### BACKGROUND

As mobile user endpoint devices have become ubiquitous, Location Based Services (LBSs) have gained popularity. LBSs are delivered based on a location of the User Endpoint (UE) device through which the user accesses the services and shares location-based information, e.g., information regarding places of interest, businesses, entertainment, a location of the UE device, etc.

One approach to determine the location of the UE is based on an estimation of a position of the UE using signals received from a Global Navigation Satellite Systems (GNSS). For example, a GNSS receiver of the UE may receive signals transmitted by satellites. Each signal may then be processed to compute a distance between the UE and the satellite that transmitted the signal. The location of the UE may be determined by processing signals from multiple satellites to determine distances between the UE and each respective satellite.

The signals from the satellites are broadcast on carrier frequencies. For example, legacy satellites of a Global Positioning System (GPS) broadcast at a carrier frequency of 1575.42 MHz, which is referred to as an L1 frequency, or as an L1 band. The L1 frequency has a chipping rate of 1 MChip/s and an effective bandwidth of about twice the chipping rate, i.e., about 2 MHz. Modernized satellites of the GPS broadcast at one or more additional carrier frequencies. For instance, an additional carrier frequency may comprise a frequency of 1176.45 MHz. The 1176.45 MHz carrier frequency is referred to as an L5 frequency, or as an L5 band. The modernized satellites that broadcast using an L5 carrier frequency use a spreading code that is ten times longer than the code used by satellites that broadcast using the L1 frequency. The effective bandwidth of the L5 is about 20 MHz and the L5 signal needs to be sampled at about ten times the sampling rate of the L1. A signal tracker designed to track signals transmitted by satellites using the L1 frequency may not be able to process signals transmitted using the L5 frequency. A brief description of the signals transmitted by satellites is provided in Section A.

One approach to design a signal tracker that can process signals from various satellites, e.g., from both legacy and modernized satellites, is to design a receiver with two sets of hardware blocks: one for the L1 band and another for the L5 band. However, this approach increases the size of the hardware block, i.e., a size of silicon area. In addition, only one of the hardware blocks is being used at a given time. Another approach is to design a hardware block that can sample and process both the L1 and L5 signals at 20 MHz. However, when the hardware block is being used for the L1, the power consumption is higher than would be needed. Since the L5 has a higher chipping rate, even if both signals transmitted using the L1 and L5 bands are sampled at a sampling rate of 20 MHz, the signal transmitted using the L1 band is inferior. If both are sampled at a sampling rate of 2 MHz, the advantage of the signal transmitted using the L5 band is lost. Therefore, the above approaches are sub-optimal.

### BRIEF DESCRIPTION OF THE DRAWINGS

The teaching of the present disclosure can be more fully understood by reading the subsequent detailed description and examples in conjunction with references made to the accompanying drawings, in which:

FIG. 1 illustrates an exemplary wireless network for providing services to wireless devices in accordance with an exemplary aspect of the present disclosure;

FIG. 2 illustrates a receiver wireless device with a signal tracker in accordance with an exemplary aspect of the present disclosure;

FIG. 3 illustrates a signal tracker in accordance with an exemplary aspect of the present disclosure;

FIG. 4 illustrates a flowchart of an example method for tracking signals in accordance with the present disclosure;

FIG. 5 illustrates a device for performing the functions described in the present disclosure; and

FIG. 6 illustrates an example processor with hardware sub-processor for implementing the tracking of signals from satellites in accordance with the present disclosure.

To facilitate reading, identical reference numbers are used to designate elements that are common to various figures, where possible.

### DETAILED DESCRIPTION

The present disclosure relates to a signal tracker and a method for tracking signals, e.g., signals from satellites or cell towers, using a processor that comprises at least one hardware sub-processor. For example, the method may be for enabling the hardware sub-processors to be used for tracking signals of various bandwidths.

Although, the present disclosure is described below for tracking signals broadcast by satellites on carrier frequencies of 1575.42 MHz and 1176.45 MHz, those ordinarily skilled in the present art realize that the signal tracker may be used for tracking signals from other sources, e.g., a Long-Term Evolution (LTE) network, a node of a wire-based network, etc. In addition, the signals may be transmitted to a receiver device wirelessly or via a wire-based network. The signals may represent locations, e.g., locations of satellites, or communication signals (e.g., audio, video, image, data, and the like).

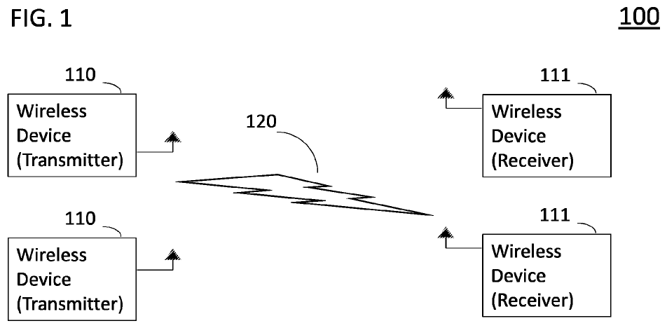

FIG. 1 illustrates an exemplary wireless network 100 for providing services to wireless devices in accordance with an exemplary aspect of the present disclosure. The wireless network comprises transmitter wireless devices 110 and receiver wireless devices 111 communicating over a wireless channel 120. For example, the wireless device 110 or 111 may be a user equipment. In addition, the wireless device may be a base station.

It is noted that the antennas of the wireless devices 110 and 111 may be antennas of a transceiver that may be used for both transmitting and receiving of a wireless signal. As such, each wireless device may be a device for transmitting or receiving the wireless signal, based on whether a Radio Frequency (RF) signal is transmitted or received by the device.

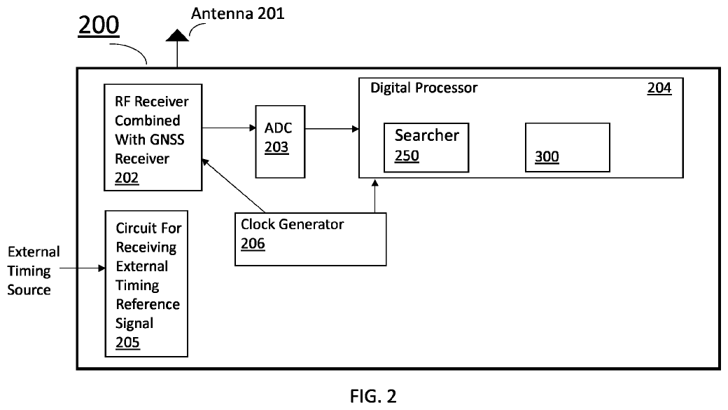

FIG. 2 illustrates a receiver wireless device 200 comprising a signal tracker in accordance with an exemplary aspect of the present disclosure. The wireless device 200 is operable to receive an RF signal. For example, the RF signal may comprise a signal from satellites and/or wireless networks, e.g., an LTE network. For example, the receiver wireless device 200 may be a wireless device 111 of FIG. 1 that includes features for tracking signals from a GNSS, e.g., a GPS. The receiver 200 may include one or more of: an antenna 201, a Radio Frequency (RF) receiver combined with a GNSS receiver 202, an Analog-to-Digital Convertor (ADC) 203, a digital processor 204, a circuit for receiving an external timing reference signal 205, a clock generator 206, etc.

In one aspect, the circuit 205 may be used to receive timing from a reference signal, e.g., a network node, a timing synchronization source, etc. The clock generator 206 may be used to provide a timing signal to the RF receiver 202 and to the digital processor 204. The timing signal is used to synchronize sampling and processing cycles. The antenna 201 is used to receive wireless signals, e.g., from a GNSS and/or wireless networks. The RF receiver 202 samples the received RF signal and forwards analog samples to the ADC 203. Then, the ADC 203 converts the analog samples to digital signals and forwards the digital signals to the digital processor 204. The digital processor 204 processes the digital signal.

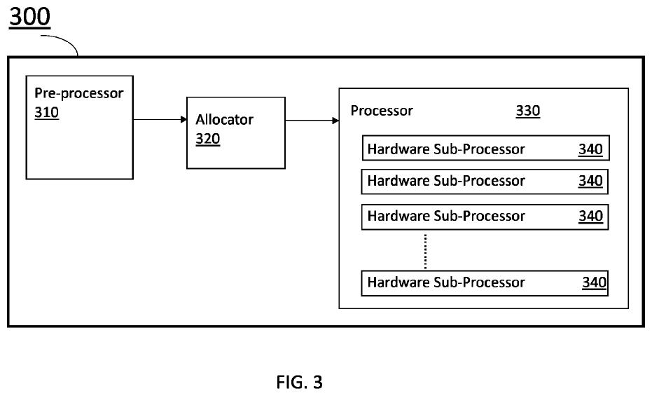

In one aspect, the processing of the digital signals in accordance with the teachings of the present disclosure includes tracking signals, e.g., signals from satellites, as described below in relation to FIG. 3. For example, the digital processor 204 may multiply a received digital signal by spreading codes of all satellites visible to the receiver (i.e., in parallel), identify signals from each satellite, compute cross-correlations, and so on. As such, in one aspect, the tracking of the signals, e.g., signals from satellites, in accordance with the present disclosure may be implemented in the digital processor 204.

In one aspect, the digital processor 204 includes a searcher 250 and a signal tracker 300, as described below. The searcher 250 may be used to determine a list of satellites visible to the receiver device such that tracking of signals is limited to signals that may be transmitted only by the visible satellites. For example, suppose the received signals represent location information related to satellites that transmit the respective signals. Then, the searcher may be used for coarsely locating satellites, while the tracker is used for precise determination of positions of satellites, and distances from the receiver device that includes the signal tracker 300 to the satellites that broadcast (i.e., transmit) the tracked signals. In one aspect, the distances to the satellites are used for determining a position of the receiver device.

FIG. 3 illustrates a signal tracker 300 in accordance with an exemplary aspect of the present disclosure. The signal tracker 300 is comprised within each receiver wireless device 200. For example, the signal tracker 300 is comprises within the digital processor 204. The signal tracker 300 comprises a pre-processor 310, an allocator 320, and a processor 330.

In one aspect, the pre-processor 310 is communicatively coupled to an ADC to receive digital signals. For example, for each sampling interval, the RF signal may be sampled. Then, samples of the sampling interval may be provided to an ADC. It is noted that samples of one sampling interval may be referred to as a “block”. In other words, a block contains samples of a predetermined duration of time, e.g., 0.25 ms, 1 ms, etc. Thus, the predetermined duration of time is referred to as a “sampling interval.” As described above, for each sampling interval (i.e., block), the samples of the RF signal (e.g., analog samples) may be provided to an ADC. In turn, for each sampling interval, the ADC may convert the analog samples to digital signals. The digital signals may then be provided to the pre-processor 310.

The pre-processor 310 is configured to, for each sampling interval of a received signal, store samples of the sampling interval at consecutive memory locations and determine a bandwidth factor. In other words, the pre-processing includes at least storing the samples in consecutive memory locations such that the samples may be sequentially accessed for processing and determining the bandwidth factor.

In one aspect, the signal is received from a satellite of one or more satellites. For example, the signal may be received from a satellite of one or more satellites of a GNSS, e.g., a GPS. In one aspect, the pre-processor is further configured to receive a list of the one or more satellites. In one aspect, the list of the one or more satellites is received from a searcher of the receiver device. For example, the digital processor may further include a searcher 250.

In one aspect, the list of the one or more satellites is received from a network node. For example, a network node, e.g., an application server, router, switch, etc., may determine an estimate of the location of the receiver device based on a base station through which the receiver device communicates with the wireless network. Then, the network node may provide a list of satellites expected to be visible to the receiver device.

In one aspect, the pre-processor is further configured to receive a type of the received signal transmitted by the satellite, a clock of the satellite or a Doppler information associated with the satellite. In one aspect, the type of the received signal transmitted by the satellite, the clock of the satellite, or the Doppler information associated with the satellite is received from a searcher of the receiver device.

In one aspect, the type of the received signal comprises: a received signal transmitted using a carrier frequency of an L1 band, or a received signal transmitted using a carrier frequency of an L5 band. In one aspect, the carrier frequency of the L1 band comprises a frequency of 1,575.42 MHz, and the carrier frequency of the L5 band comprises a frequency of 1,176.45 MHz.

It is noted that the sampling rates of the signals received using the L5 band are higher than the sampling rate of the signals received using the L1 band. Therefore, for a given time interval, there are more samples when the received signal is using a frequency of the L5 band.

In one aspect, the pre-processing may further include storing and retrieving channel contexts such that a processing of samples stored in one memory location may be referenced when samples stored in a next memory location are being processed.

In one aspect, samples of received signals from all of the one or more satellites are stored in a memory, wherein the memory includes the consecutive memory locations. For the example described above, the memory may be used for storing samples from all of the one or more satellites. In another example, the memory may be used for storing samples from any base station of a wireless network, e.g., an LTE network.

In one aspect, the bandwidth factor is determined by dividing a sampling rate of the received signal by a sampling rate of a legacy signal and rounding up a result of the dividing to a closest integer, wherein the legacy signal is a signal transmitted using a carrier frequency of 1,575.42 MHz. For example, if the sampling rate of the received signal is 18 MHz and the sampling rate of the signal having the basic bandwidth is 10 MHz, the bandwidth factor may be set to two (i.e., round up to 2 from 1.8).

In one aspect, the bandwidth factor is determined by dividing a sampling rate of the received signal by a sampling rate of a signal having a basic bandwidth. For the example above, the signal having a basic bandwidth comprises a signal transmitted by a legacy satellite using a carrier frequency of 1,575.42 MHz (i.e., L1). In another example, the signal having the basic bandwidth may comprise a signal transmitted using another carrier frequency, e.g. from another GNSS.

The allocator 320 is coupled to the pre-processor 310 and configured to, for each sampling interval, allocate the samples stored at each of the memory locations to a respective one of consecutive tracking channels in consecutive processing cycles.

In one aspect, a number of the consecutive tracking channels is equal to the bandwidth factor and a number of the consecutive processing cycles is greater than or equal to the bandwidth factor.

The processor 330, coupled to the allocator 320 and comprising at least one Hardware Sub-Processors (HSPs) 340, is configured to, for each sampling interval, sequentially process the samples of the sampling interval in accordance with the allocation, each hardware sub-processor configured to track one of the consecutive tracking channels. In one aspect, the hardware sub-processor comprises a circuit that performs processing of the samples. The processing of the samples may be to retrieve information, e.g., location information of satellites, communication information, etc.

In one aspect, when the signals are received from the one or more satellites, the processor is further configured to determine a position of a satellite of the one or more satellites that transmitted the received signal.

In one aspect, when the signals are received from the one or more satellites, the processor 330 is further configured to determine a location of a receiver device based on positions of the one or more satellites, and a respective distance between the receiver device and the respective positions of the one or more satellites. For example, the receiver device may receive signals from multiple satellites. Then, the receiver device may compute distances to each of the multiple satellites. The multiple distances to respective satellites may be used for triangulation to determine the location of the receiver device.

In one aspect, the location of the receiver device comprises at least a latitudinal and a longitudinal location. In another aspect, the location of the receiver device further comprises an altitudinal location of the receiver device.

In one aspect, the distance between the receiver device and a position of a satellite of the one or more satellites is determined based on a time difference between when the satellite transmits the received signal and when the receiver device receives the received signal. For example, the received signal may include when the signal was transmitted by the satellite. In addition, the receiver device includes a clock that enables the receiver device to determine when the signal is received. The time difference for the signal to traverse from the satellite to the receiver device may then be computed. Note that if the receiver device is not synchronized to the satellite, the difference between the clock of the satellite and the clock of the receiver device is also used for the computation. In one aspect, the difference between the clocks may be obtained from a network a-priori.

In one aspect, a difference between a clock of the receiver device and a clock of the satellite that transmits the received signal is known to the receiver device. In one aspect, clocks of the one or more satellites are synchronized. For example, the clocks of all satellites in a GNSS may be synchronized.

In one aspect, when the received signal comprises a signal transmitted by a satellite of the one or more satellites using a carrier frequency of 1,575.42 MHz, the received signal is processed by one hardware sub-processor in one processing cycle. For example, each hardware sub-processor may be designed to have a processing power sufficient to process samples of a signal received in on sampling interval, when the samples are received using a frequency of the L1 band. In contrast, for samples of a received signals using a frequency of the L5 band within a same processing sampling interval, a plurality of hardware sub-processors may be used.

For a non-limiting illustrative example, suppose a signal received from a modernized satellite uses the L5 band and is sampled at twice the sampling rate of the basic bandwidth (e.g., L1). Then, the bandwidth factor is set to two and samples of the signal received from the modernized satellite using the L5 band are stored in two consecutive memory locations of a memory, e.g., a buffer. Accordingly, two consecutive tracking channels from in consecutive processing cycles are allocated. An illustrative example is described below in Section B.

Once the tracking channels are allocated, the samples of the signal received from the modernized satellite using the L5 band are sequentially processed by the first and second hardware sub-processors. For instance, the samples stored in the first memory location are processed by the first hardware sub-processor. It is noted that the first hardware sub-processor is associated with the first tracking channel of the two consecutive tracking channels allocated for the samples of the received signal. Similarly, the second hardware sub-processor is associated with the second tracking channel of the two consecutive tracking channels allocated for the samples of the received signal. When the first hardware sub-processor completes processing the samples stored in the first memory location, a channel context is stored in memory. In turn, the stored channel context is retrieved (i.e., loaded) by the second hardware sub-processor when it begins processing samples stored in the second memory location. Then, samples stored in the second memory location are processed by the second hardware sub-processor.

Note that the processing of the samples stored in the second memory location occurs in a processing cycle following the processing cycle during which the samples stored in the first memory location are processed. When the second hardware sub-processor completes processing the samples stored in the second memory location, a channel context is stored in memory for handing over to the first hardware sub-processor. Thus, the sequential processing includes processing samples stored in consecutive memory locations by respective hardware sub-processors. The hardware sub-processors are associated with consecutive tracking channels, and the consecutive tracking channels are in consecutive processing cycles. In other words, due to the handing over a result of the processing by one hardware sub-processor to another hardware sub-processor via a channel context, the processing of samples stored in two memory locations is not performed in a same processing cycle.

The hardware sub-processors of the present disclosure are used for any type of signal, e.g., L1, L5, and the like. Therefore, the hardware sub-processors would be idle only when there is no signal being received from any satellite. Since the hardware sub-processors can be used for any type of signal, the silicon area used for tracking signals from satellites may be designed optimally. In addition, the idle time of the processor is reduced, thereby optimizing power usage for tracking purposes.

In the examples above, the L1 signal was processed in one processing cycle. However, based on the location of the satellite and the quality of the signal being received from the satellite, it may be beneficial to allow different sampling rates for signals using the L1 band. Thus, a “basic hardware sub-processor” may be defined. In one aspect, the basic hardware sub-processor is defined for processing at the effective bandwidth of the L1, i.e., 2 MHz. However, the L1 or the L5 signal my use multiple hardware sub-processors. For example, for satellites that are closer to the receiver device and having a high Signal-to-Noise Ratio (SNR), one basic hardware sub-processor may suffice. In contrast, when the satellite is farther away or has a low SNR, the L1 signal may be sampled at an integer multiple of the effective bandwidth, e.g., at 4 MHz, 6 MHz, 8 MHz, etc. As such, a plurality of basic hardware sub-processors may be used for such signals. When the basic hardware sub-processor supports the effective bandwidth of the L1 (i.e., 2 MHz), ten hardware sub-processors are needed for the L5 to support the sampling rate of 20 MHz.

In one aspect, the basic hardware sub-processor may further be used to provide compatibility for signals being received from various GNSSs. For example, signals from satellites of Galileo, Glonass, etc., may have different effective bandwidths as compared to signals received from a Global Positioning System (GPS). The GNSSs are described in Section A. Then, a smallest effective bandwidth may be selected for a basic hardware sub-processor. The signals from the other GNSSs may then use any number of the basic hardware sub-processors, as needed.

In one aspect, as described above, the received signals may represent satellite locations. However, the modular tracker may be used for signals that represent other content, e.g., a communications content. As such, the basic hardware sub-processor may be for processing a signal having a basic bandwidth, the basic bandwidth being associated with a smallest granularity for signals being tracked. In other words, the hardware sub-processors may be used for tracking signals with different bandwidth, with each signal being tracked having a bandwidth which is an integer multiple of the basic bandwidth (e.g., twice the basic bandwidth, three times the basic bandwidth, etc.). Each of the signals being tracked may reach the receiver wirelessly or via a wire-based network.

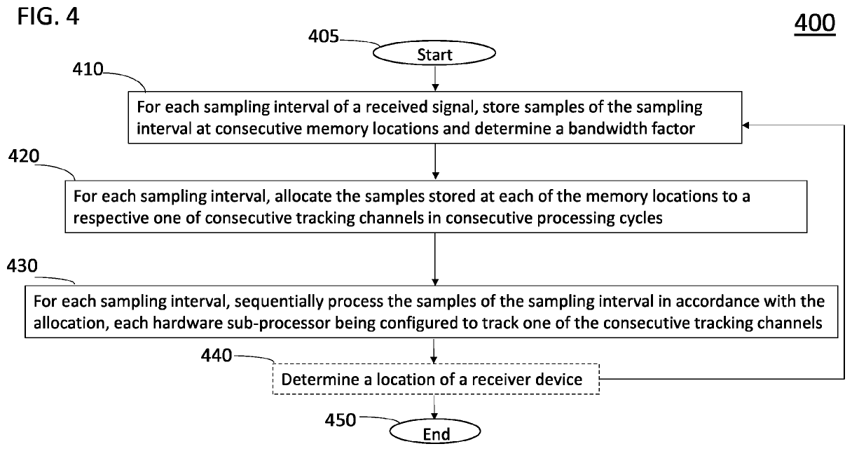

FIG. 4 illustrates a flowchart of an example method 400 for tracking signals in accordance with the present disclosure.

In one aspect of the present disclosure, the method 400 may be implemented in a network device that comprises a receiver configured to receive signals and a signal tracker, e.g., signal tracker 300, for processing the signals. For example, the method 400 may be implemented in a signal tracker 300 wherein storing samples of the sampling interval at consecutive memory locations and the determining of the bandwidth factor are performed by pre-processor 310, the allocating, for each sampling interval, the samples stored at each of the memory locations to a respective one of consecutive tracking channels in consecutive processing cycles is performed by allocator 320, and the sequentially processing, for each sampling interval, the samples of the sampling interval in accordance with the allocation is performed by the hardware 330 comprising hardware sub-processors 340. In another example, the method 400 may be implemented in a device 500, described below.

The method 400 starts in step 405 and proceeds to step 410.

In step 410, the method, for each sampling interval of a received signal, by the pre-processor 310, stores samples of the sampling interval at consecutive memory locations and determines a bandwidth factor.

In step 420, the method allocates, by the allocator 320, for each sampling interval, the samples stored at each of the memory locations to a respective one of consecutive tracking channels in consecutive processing cycles.

In step 430, the method, by the processor 330 comprising at least one hardware sub-processor 340, for each sampling interval, sequentially processes the samples of the sampling interval in accordance with the allocation, wherein each hardware sub-processor tracks one of the consecutive tracking channels.

In one aspect, the signal is received from a satellite of the one or more satellites, and the processor also determines a position of the satellite that transmitted the received signal.

In optional step 440, when signals are received from one or more satellites, the method, by the processor 330, determines a location of a receiver device, e.g., the network device that comprises the receiver, based on positions of the one or more satellites, and a respective distance between the receiver device and the respective positions of the one or more satellites. The method may then proceed to step 450 to end the tracking of signals or to step 410 to receive more samples of a signal.

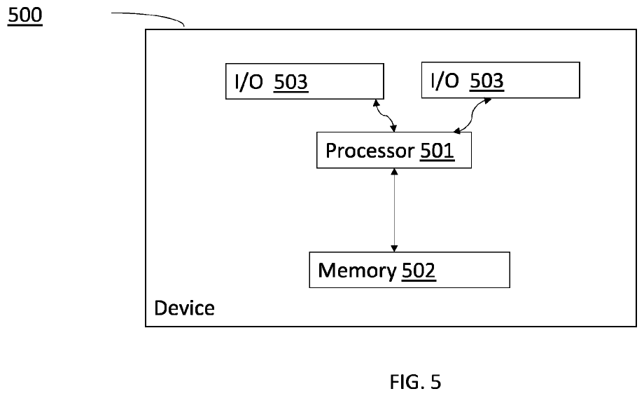

FIG. 5 illustrates a device 500 for performing the functions described in the present disclosure. The device 500 comprises a processor 501 and a memory 502 configured to store a program instructions to be executed by the processor 501, where executing the program instructions causes the processor 501 to perform operations for tracking signals, the operations comprising, for each sampling interval of a received signal, storing samples of the sampling interval at consecutive memory locations, determining a bandwidth factor, allocating the samples stored at each of the memory locations to a respective one of consecutive tracking channels in consecutive processing cycles, and sequentially processing the samples of the sampling interval in accordance with the allocation. When the signal comprises a signal received from one or more satellites, the operations further comprising, determining a position of the satellite of the one or more satellites that transmitted the received signal. The device 500 may further comprise any number and type of input/output devices 503.

It is noted that although FIG. 4 illustrates a single device, the method 400 may be implemented via any number of devices performing the operations of method 400 in a distributed manner, serial manner, or a combination thereof. In addition, the devices may be virtualized devices instantiated on servers (e.g., servers of a cloud network). As such, the representation of the hardware components of the device may be a virtualized or a physical representation, without departing from the teaching of the present disclosure. Accordingly, the method 400 may be implemented in hardware, software, or a combination thereof. It is noted that the processor 501 executing the program instructions includes the processor 501 performing the operations of the method 400 directly or indirectly. For example, the processor 501 may perform the operations in conjunction with other devices or may direct another device to perform the operations.

It should be understood that the aspects of the present disclosure are described above by way of examples. However, the various aspects are exemplary and not limitations. Thus, the scope of the present disclosure should not be construed as being limited by any of the above aspects or examples. The breadth and the scope of the present disclosure should be defined in accordance with the scope and breadth of the following claims and/or equivalents.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processor circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### A. A Brief Description of Signals Transmitted by Satellites on Carrier Frequencies

A user endpoint device may determine its location based on signals transmitted by Global Navigation Satellite Systems (GNSS). Some examples of a GNSS are: a GNSS of the United States referred to as a Global Positioning System (GPS), a GNSS of Russia referred to as GLObal′naya NAvigatsionnaya Sputnikovaya Sistema (GLONASS), a GNSS of Europe referred to as Gallileo, a GNSS of China referred to as COMPASS, and so on. Satellites of the various GNSSs circle the earth twice daily. Currently, a receiver located at an unobstructed location may have visibility to 4-12 satellites. As more satellites are deployed, the number of visible satellites to a UE may increase.

The signals may be transmitted by satellites on various carrier frequencies, e.g., L1, L2 and/or L5. Each signal transmitted by a satellite comprises ranging signals and navigation messages. The ranging signals are coded.

Signals using the L1 and/or L2 carrier frequencies comprise two ranging codes: Coarse Acquisition (C/A) codes and Precision (P) codes. The C/A code includes a pseudorandom sequence of length 1,023 chips at a chipping frequency of 1.023 MHz modulating the carrier signal. Hence, the C/A code has a period of 1 ms. The precision code includes a signal of length 6.1871X 10\hat{ }12 bits transmitted at a chipping frequency of 10.23 MHz. The precision code repeats only once a week.

The navigation messages include status data and location data. The status data includes an indication as to a health of the satellite and a clock. Note that the satellites have atomic clocks which are monitored and synchronized among the various satellites. The clocks of the satellites are assumed to be accurate. In addition, the receiver devices are designed with internal clocks. The internal clock of a receiver device enables the device to determine a time at which the receiver device generates a signal and a time at which the receiver device receives a signal, e.g., a signal transmitted by a satellite. The receiver device converts the time between transmission of the signal by the satellite and the reception of the signal by the receiver device to a distance. The distance may also be referred to as “ranging information.”

The location data comprises an almanac that consists an orbit and status information for each satellite in the constellation. The location data also comprises ephemeris data which provides orbital information for the satellite transmitting the signal. Each satellite transmits its own ephemeris data to enable a receiver to compute a position of the satellite transmitting the signal. Therefore, the ephemeris data is used for determining the positon of the satellite from a perspective of the receiver.

For signals using the L5 carrier frequency, the signal is Quadrature Phase Shift Keying (QPSK) modulated. Two ranging codes comprising an in-phase code and a quadrature code are transmitted. Different spreading codes are used for the in-phase and quadrature components. Both codes comprise 10,230 bits transmitted at a frequency of 10.23 MHz. The codes are repeated with an interval of 1 ms. The in-phase component is modulated with a navigation data and a Neuman-Huffman code at a frequency of 1 kHz. The quadrature component carries no navigation data and is modulated with a Neuman-Huffman code at a frequency of 1 kHz.

As described above, the signal transmitted using the L5 frequency uses a spreading code that is ten times longer than the code used for signals transmitted using the L1 frequency (i.e., the length of the C/A is one tenth the length of the spreading code used for L5). The effective bandwidth of the signal transmitted using the L5 frequency is about 20 MHz and that of the L1 is about 2 MHz.

### B. Illustrative Example

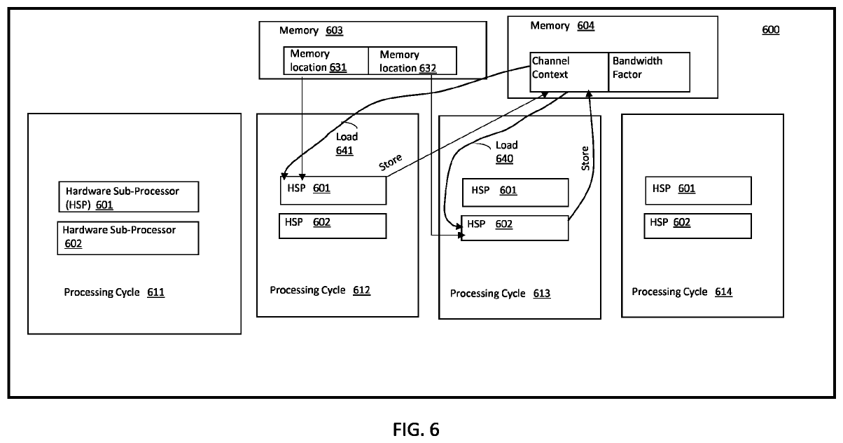

FIG. 6 illustrates an example processor 600 with hardware sub-processors for implementing the tracking of signals from satellites in accordance with the present disclosure. The processor 600 comprises two hardware sub-processors 601 and 602, for processing samples, a memory 603 for storing the samples, a memory 604 for storing channel contexts and bandwidth factors. For a sampling interval (e.g., a 0.25 ms), each hardware sub-processor is able to run four processing cycles for a legacy signal, as shown in 611-614. It is noted that the hardware sub-processors (HSPs) 601 and 602 are exemplary implementations of the hardware sub-processor 340, described in relation to FIG. 3. It is noted that samples that are obtained in one sampling interval may be referred to as a “block” or as a “block of samples.”

Suppose the sampling rate of a basic bandwidth is such that one block of samples of a signal using an L1 band contains 4000 bits. Suppose also the sampling rate of a signal using the L5 band is such that one block of samples contains 8000 bits. That is, the signal using the L5 band is sampled at twice the sampling rate of the signal using the L1 band. When a pre-processor receives samples of a signal that uses the L5 band, the first 4000 bits are stored in a memory location 631 of the memory 603, and the second 4000 bits are stored in a memory location 632 of the memory 603. The pre-processor computes and stores the bandwidth factor in memory 604. In addition, channel contexts are stored in memory 604.

As describes above, there are four processing cycles 611-614. The allocator then allocates the samples stored in memory locations 631 and 632 to two consecutive tracking channels in two of the four processing cycles. For example, tracking channel one in processing cycle 611 and tracking channel two in processing cycle 612, tracking channel one in processing cycle 612 and tracking channel two in processing cycle 613, or tracking channel one in processing cycle 613 and tracking channel two in processing cycle 614, may be allocated. For instance, suppose tracking channel one in processing cycle 612 and tracking channel two in processing cycle 613 are allocated. Then, the samples stored in memory location 631 are allocated to tracking channel one in processing cycle 612 and samples stored in memory location 632 are allocated to tracking channel two in processing cycle 613. Then, the first 4000 bits are processed by hardware sub-processor 601 during processing cycle 612 and a channel context is stored in memory 604. At the beginning of the processing cycle 613, hardware sub-processor 602 loads the channel context, as shown in 640, and processes the second 4000 bits. Then, hardware sub-processor 602 stores a channel context in memory 604. At the beginning of a next sampling interval, hardware sub-processor 601 loads the channel context, as shown in 641, and processes the first 4000 bits of the next sampling interval.

As more samples are received for subsequent sampling intervals, the location computations are updated. For example, the locations of the satellites are updated. In another example, ranging information is used to compute distances between the satellites and the receiver device. The location of the receiver device may then be updated.

The following examples pertain to further embodiments.

Example 1 is a signal tracker, comprising: a pre-processor, configured to, for each sampling interval of a received signal, store samples of the sampling interval at consecutive memory locations and determine a bandwidth factor; an allocator, coupled to the pre-processor, and configured to, for each sampling interval, allocate the samples stored at each of the memory locations to a respective one of consecutive tracking channels in consecutive processing cycles; and a processor, coupled to the allocator and comprising at least one hardware sub-processor, and configured to, for each sampling interval, sequentially process the samples of the sampling interval in accordance with the allocation, wherein each hardware sub-processor is configured to track one of the consecutive tracking channels.

In Example 2, the subject matter of Example 1, wherein a number of the consecutive tracking channels is equal to the bandwidth factor and a number of the consecutive processing cycles is greater than or equal to the bandwidth factor.

In Example 3, the subject matter of Example 1, wherein the signal is received from a satellite of one or more satellites, and the processor is further configured to determine a position of the satellite that transmitted the received signal.

In Example 4, the subject matter of Example 3, wherein the bandwidth factor is determined by dividing a sampling rate of the received signal by a sampling rate of a legacy signal and rounding up is a result of the dividing to a closest integer, wherein the legacy signal is a signal transmitted using a carrier frequency of 1,575.42 MHz.

In Example 5, the subject matter of Example 3, wherein samples of received signals from all of the one or more satellites are stored in a memory, and the memory includes the consecutive memory locations.

In Example 6, the subject matter of Example 3, wherein the pre-processor is further configured to receive a list of the one or more satellites from a searcher of the receiver device.

In Example 7, the subject matter of Example 3, wherein the pre-processor is further configured to receive a list of the one or more satellites from a network node.

In Example 8, the subject matter of Example 3, wherein the pre-processor is further configured to receive a type of the received signal transmitted by the satellite, a clock of the satellite, or a Doppler information associated with the satellite.

In Example 9, the subject matter of Example 8, wherein the type of the received signal transmitted by the satellite, the clock of the satellite, or the Doppler information associated with the satellite is received from a searcher of the receiver device.

In Example 10, the subject matter of Example 8, wherein the type of the received signal comprises a received signal transmitted using a carrier frequency of an L1 band, or a received signal transmitted using a carrier frequency of an L5 band.

In Example 11, the subject matter of Example 10, wherein the carrier frequency of the L1 band comprises a frequency of 1,575.42 MHz, and the carrier frequency of the L5 band comprises a frequency of 1,176.45 MHz.

In Example 12, the subject matter of Example 3, wherein the processor is further configured to determine a location of a receiver device based on positions of the one or more satellites, and a respective distance between the receiver device and the respective positions of the one or more satellites.

In Example 13, the subject matter of Example 12, wherein the location of the receiver device comprises at least a latitudinal and a longitudinal location.

In Example 14, the subject matter of Example 13, wherein the location of the receiver device further comprises an altitudinal location of the receiver device.

In Example 15, the subject matter of Example 12, wherein the distance between the receiver device and a position of a satellite of the one or more satellites is determined based on a time difference between when the satellite transmits the received signal and when the receiver device receives the received signal.

In Example 16, the subject matter of Example 15, wherein a difference between a clock of the receiver device and a clock of the satellite that transmits the received signal is known to the receiver device.

In Example 17, the subject matter of Example 3, wherein clocks of the one or more satellites are synchronized.

In Example 18, the subject matter of Example 3, wherein when the received signal comprises a signal transmitted using a carrier frequency of 1,575.42 MHz, the received signal is processed by one hardware sub-processor in one processing cycle.

In Example 19, the subject matter of Example 3, wherein the one or more satellites are satellites of one of more Global Navigation Satellite Systems (GNSSs).

Example 20 is a wireless device, comprising: a receiver configured to receive a signal; and the signal tracker of the subject matter of Example 1.

In Example 21, the subject matter of Example 20, wherein the signal is received from a satellite, and the signal tracker is further configured to: determine a position of the satellite.

Example 22 is a method for tracking signals, the method comprising: for each sampling interval of a received signal, by pre-processor, stores samples of the sampling interval at consecutive memory locations and determines a bandwidth factor; for each sampling interval, by an allocator, allocates the samples stored at each of the memory locations to a respective one of consecutive tracking channels in consecutive processing cycles; and for each sampling interval, by a processor comprising the at least one hardware sub-processor, sequentially processes the samples of the sampling interval in accordance with the allocation, wherein each hardware sub-processor tracks one of the consecutive tracking channels.

In Example 23, the subject matter of Example 22, wherein the signal is received from a satellite, and the method further comprising: determining, by the processor, a position of the satellite.

Example 24 is a device comprising: a processor; and a memory configured to store a program instructions to be executed by the processor, where executing the program instructions causes the processor to perform operations for tracking signals, the operations comprising: for each sampling interval of a received signal, storing samples of the sampling interval at consecutive memory locations and determining a bandwidth factor; for each sampling interval, allocating the samples stored at each of the memory locations to a respective one of consecutive tracking channels in consecutive processing cycles; and for each sampling interval, sequentially processing the samples of the sampling interval in accordance with the allocation, wherein each tracking channel of the consecutive tracking channels is tracked by a hardware sub-processor different from a hardware sub-processor tracking another tracking channel of the consecutive tracking channels.

In Example 25, the subject matter of Example 24, wherein the signal is received from a satellite, and the operations further comprising: determining a position of the satellite.

Example 26 is a signal tracker, comprising: a pre-processor, configured to, for each sampling interval of a received signal, store samples of the sampling interval at consecutive memory locations and determine a bandwidth factor; an allocator, coupled to the pre-processor, and configured to, for each sampling interval, allocate the samples stored at each of the memory locations to a respective one of consecutive tracking channels in consecutive processing cycles; and a processor, coupled to the allocator and comprising at least one hardware sub-processor, and configured to, for each sampling interval, sequentially process the samples of the sampling interval in accordance with the allocation, wherein each hardware sub-processor is configured to track one of the consecutive tracking channels.

In Example 27, the subject matter of Example 26, wherein a number of the consecutive tracking channels is equal to the bandwidth factor and a number of the consecutive processing cycles is greater than or equal to the bandwidth factor.

In Example 28, the subject matter of Example 26, wherein the signal is received from a satellite of one or more satellites, and the processor is further configured to determine a position of the satellite that transmitted the received signal.

In Example 29, the subject matter of Example 28, wherein the bandwidth factor is determined by dividing a sampling rate of the received signal by a sampling rate of a legacy signal and rounding up is a result of the dividing to a closest integer, wherein the legacy signal is a signal transmitted using a carrier frequency of 1,575.42 MHz.

In Example 30, the subject matter of Example 28, wherein samples of received signals from all of the one or more satellites are stored in a memory, and the memory includes the consecutive memory locations.

In Example 31, the subject matter of Example 28, wherein the pre-processor is further configured to receive a list of the one or more satellites from a searcher of the receiver device.

In Example 32, the subject matter of Example 28, wherein the pre-processor is further configured to receive a list of the one or more satellites from a network node.

In Example 33, the subject matter of Example 28, wherein the pre-processor is further configured to receive a type of the received signal transmitted by the satellite, a clock of the satellite, or a Doppler information associated with the satellite.

In Example 34, the subject matter of Example 33, wherein the type of the received signal transmitted by the satellite, the clock of the satellite, or the Doppler information associated with the satellite is received from a searcher of the receiver device.

In Example 35, the subject matter of Example 33, wherein the type of the received signal comprises a received signal transmitted using a carrier frequency of an L1 band, or a received signal transmitted using a carrier frequency of an L5 band.

In Example 36, the subject matter of Example 35, wherein the carrier frequency of the L1 band comprises a frequency of 1,575.42 MHz, and the carrier frequency of the L5 band comprises a frequency of 1,176.45 MHz.

In Example 37, the subject matter of Example 28, wherein the processor is further configured to determine a location of a receiver device based on positions of the one or more satellites, and a respective distance between the receiver device and the respective positions of the one or more satellites.

In Example 38, the subject matter of Example 37, wherein the location of the receiver device comprises at least a latitudinal and a longitudinal location.

In Example 39, the subject matter of Example 38, wherein the location of the receiver device further comprises an altitudinal location of the receiver device.

In Example 40, the subject matter of Example 37, wherein the distance between the receiver device and a position of a satellite of the one or more satellites is determined based on a time difference between when the satellite transmits the received signal and when the receiver device receives the received signal.

In Example 41, the subject matter of Example 40, wherein a difference between a clock of the receiver device and a clock of the satellite that transmits the received signal is known to the receiver device.

In Example 42, the subject matter of Example 28, wherein clocks of the one or more satellites are synchronized.

In Example 43, the subject matter of Example 28, wherein when the received signal comprises a signal transmitted using a carrier frequency of 1,575.42 MHz, the received signal is processed by one hardware sub-processor in one processing cycle.

In Example 44, the subject matter of Example 28, wherein the one or more satellites are satellites of one of more Global Navigation Satellite Systems (GNSSs).

Example 45 is a wireless device, comprising: a receiver configured to receive a signal; and the signal tracker of the subject matter of any of Examples 26-44.

In Example 46, the subject matter of Example 45, wherein the signal is received from a satellite, and the signal tracker is further configured to: determine a position of the satellite.

1-25. (canceled)

26. A signal tracker, comprising:
a pre-processor, configured to, for each sampling interval of a received signal, store samples of the sampling interval at consecutive memory locations and determine a bandwidth factor;
an allocator, coupled to the pre-processor, and configured to, for each sampling interval, allocate the samples stored at each of the memory locations to a respective one of consecutive tracking channels in consecutive processing cycles; and
a processor, coupled to the allocator and comprising at least one hardware sub-processor, and configured to, for each sampling interval, sequentially process the samples of the sampling interval in accordance with the allocation, wherein each hardware sub-processor is configured to track one of the consecutive tracking channels.

27. The signal tracker of claim 26, wherein a number of the consecutive tracking channels is equal to the bandwidth factor and a number of the consecutive processing cycles is greater than or equal to the bandwidth factor.

28. The signal tracker of claim 26, wherein the signal is received from a satellite of one or more satellites, and the processor is further configured to determine a position of the satellite that transmitted the received signal.

29. The signal tracker of claim 28, wherein the bandwidth factor is determined by dividing a sampling rate of the received signal by a sampling rate of a legacy signal and rounding up is a result of the dividing to a closest integer, wherein the legacy signal is a signal transmitted using a carrier frequency of 1,575.42 MHz.

30. The signal tracker of claim 28, wherein samples of received signals from all of the one or more satellites are stored in a memory, and the memory includes the consecutive memory locations.

31. The signal tracker of claim 28, wherein the pre-processor is further configured to receive a list of the one or more satellites from a searcher of the receiver device.

32. The signal tracker of claim 28, wherein the pre-processor is further configured to receive a list of the one or more satellites from a network node.

33. The signal tracker of claim 28, wherein the pre-processor is further configured to receive a type of the received signal transmitted by the satellite, a clock of the satellite, or a Doppler information associated with the satellite.

34. The signal tracker of claim 33, wherein the type of the received signal transmitted by the satellite, the clock of the satellite, or the Doppler information associated with the satellite is received from a searcher of the receiver device.

35. The signal tracker of claim 33, wherein the type of the received signal comprises a received signal transmitted using a carrier frequency of an L1 band, or a received signal transmitted using a carrier frequency of an L5 band.

36. The signal tracker of claim 35, wherein the carrier frequency of the L1 band comprises a frequency of 1,575.42 MHz, and the carrier frequency of the L5 band comprises a frequency of 1,176.45 MHz.

37. The signal tracker of claim 28, wherein the processor is further configured to determine a location of a receiver device based on positions of the one or more satellites, and a respective distance between the receiver device and the respective positions of the one or more satellites.

38. The signal tracker of claim 37, wherein the location of the receiver device comprises at least a latitudinal and a longitudinal location.

39. The signal tracker of claim 38, wherein the location of the receiver device further comprises an altitudinal location of the receiver device.

40. The signal tracker of claim 37, wherein the distance between the receiver device and a position of a satellite of the one or more satellites is determined based on a time difference between when the satellite transmits the received signal and when the receiver device receives the received signal.

41. The signal tracker of claim 40, wherein a difference between a clock of the receiver device and a clock of the satellite that transmits the received signal is known to the receiver device.

42. The signal tracker of claim 28, wherein clocks of the one or more satellites are synchronized.

43. The signal tracker of claim 28, wherein when the received signal comprises a signal transmitted using a carrier frequency of 1,575.42 MHz, the received signal is processed by one hardware sub-processor in one processing cycle.

44. The signal tracker of claim 28, wherein the one or more satellites are satellites of one of more Global Navigation Satellite Systems (GNSSs).

45. A wireless device, comprising:
a receiver configured to receive a signal; and
the signal tracker of claim 26.

46. The wireless device of claim 45, wherein the signal is received from a satellite, and the signal tracker is further configured to:
determine a position of the satellite.

47. A method for tracking signals, the method comprising:
for each sampling interval of a received signal, by pre-processor, stores samples of the sampling interval at consecutive memory locations and determines a bandwidth factor;
for each sampling interval, by an allocator, allocates the samples stored at each of the memory locations to a respective one of consecutive tracking channels in consecutive processing cycles; and
for each sampling interval, by a processor comprising the at least one hardware sub-processor, sequentially processes the samples of the sampling interval in accordance with the allocation, wherein each hardware sub-processor tracks one of the consecutive tracking channels.

48. The method of claim 47, wherein the signal is received from a satellite, and the method further comprising:
determining, by the processor, a position of the satellite.

49. A device comprising:
a processor; and
a memory configured to store a program instructions to be executed by the processor, where executing the program instructions causes the processor to perform operations for tracking signals, the operations comprising:
for each sampling interval of a received signal, storing samples of the sampling interval at consecutive memory locations and determining a bandwidth factor;
for each sampling interval, allocating the samples stored at each of the memory locations to a respective one of consecutive tracking channels in consecutive processing cycles; and
for each sampling interval, sequentially processing the samples of the sampling interval in accordance with the allocation, wherein each tracking channel of the consecutive tracking channels is tracked by a hardware sub-processor different from a hardware sub-processor tracking another tracking channel of the consecutive tracking channels.

50. The device of claim 49, wherein the signal is received from a satellite, and the operations further comprising:
determining a position of the satellite.
